(19) United States
(12) Patent Application Publication
(10) Pub. No.: US 2008/0134467 A1
(43) Pub. Date: Jun. 12, 2008

(54) Electronic device

(75) Inventors: Chien-Sheng Cheng, Taipei (TW); Kan-Yu Chu, Taipei (TW); Chien-Chun Chiu, Taipei (TW); Chine-Hsum Wu, Taipei (TW); Shyang-Lin Wang, Taipei (TW); Feng-Hsu Chang, Taipei (TW)

Correspondence Address: BIRCH STEWART KOLASCH & BIRCH, PO BOX 747, FALLS CHURCH, VA, 22040-0747, US

(73) Assignee: INVENTEC CORPORATION

(21) Appl. No.: 11/725,452

(22) Filed: Mar. 20, 2007

(30) Foreign Application Priority Data
Dec. 6, 2006 (TW) 095145338

(51) Int. Cl. E05D 11/06

(52) U.S. Cl. 16/320; 361/681

(57) ABSTRACT

An electronic device includes a first housing, a second housing, an axle and a first electromagnetic valve. The second housing is disposed adjacent to one side of the first housing. The first housing and the second housing are both pivoted on the axle, and the first housing and the second housing can be opened/closed around the axle. The first electromagnetic valve is disposed adjacent to the axle to lock/unlock the axle. When the first electromagnetic valve unlocks the axle, the first housing and the second housing may be opened/closed. Alternatively, when the first electromagnetic valve locks the axle, the first housing and the second housing cannot be opened/closed.

### BACKGROUND OF THE INVENTION

1. Field of Invention

The invention relates to an electronic device, and, in particular, to an electronic device possessing an electromagnetic valve.

2. Related Art

FIG. 1 shows a conventional electronic device 1, which includes a first housing 11, a second housing 12, two torque generating assemblies 13 and a locking assembly 14. The second housing 12 is pivotally mounted on one side of the first housing 11, and the second housing 12 can be rotated relative to the first housing 11.

The torque generating assemblies 13 are disposed between the first housing 11 and the second housing 12, and each torque generating assembly 13 has a first connection portion 131 and a second connection portion 132. The first connection portion 131 is connected to the first housing 11, the second connection portion 132 is connected to the second housing 12, and the torque generating assembly 13 can provide a torsional force. When the user wants to change the angle between the first housing 11 and the second housing 12, an external force has to be applied to the second housing 12, and the applied torque caused by the applied external force has to be greater than the torque caused by the torsional forces provided by the torque generating assemblies 13. Thus, the first housing 11 and the second housing 12 can be rotated relative to each other. When the user removes the external force applied to the second housing 12, the torsional forces of the torque generating assemblies 13 can keep the first housing 11 and the second housing 12 stationary so that the first housing 11 and the second housing 12 may be fixed to each other.

The locking assembly 14 has a hook 141 and a groove 142. When the second housing 12 is closed on the first housing 11, the hook 141 can enter the groove 142 so that the second housing 12 and the first housing 11 cannot be opened and the first housing 11 and the second housing 12 may be closed.

However, the user has to apply the external force to produce the torque greater than that produced by the torsional forces of the torque generating assemblies 13 so that the first housing 11 and the second housing 12 may be rotated relative to each other. If the user improperly applies the force, the center of gravity of the electronic device 1 may be shifted, and the electronic device 1 may tilt down and thus be damaged. In addition, the torque generating assembly 13 and the locking assembly 14 have many members, so assembling procedures of the electronic device 1 are complicated, the working time and the cost are expensive, and the manufacturing quality is also problematic.

### SUMMARY OF THE INVENTION

In view of the foregoing, the invention is to provide an electronic device, which does not tilt down and thus does not become damaged. Furthermore, it may be manufactured more quickly, with reduced cost and improved quality.

To achieve the above, the invention discloses an electronic device, which includes a first housing, a second housing, an axle and a first electromagnetic valve. The second housing is disposed adjacent to one side of the first housing. The first housing and the second housing are both pivoted on the axle, and the first housing and the second housing may be rotated relative to each other via the axle. The first electromagnetic valve is disposed adjacent to the axle to lock/unlock the axle. When the first electromagnetic valve unlocks the axle, the first housing and the second housing may be rotated relative to each other. When the first electromagnetic valve locks the axle, the first housing and the second housing are fixed to each other and cannot be rotated relative to each other.

As mentioned hereinabove, the electronic device of the invention includes the first electromagnetic valve or may further include the second electromagnetic valve and the electromagnetic valve switch. Thus, the user can control the first electromagnetic valve and the second electromagnetic valve to unlock or lock the axle through the electromagnetic valve switch so as to control the first housing and the second housing to be rotated relative to each other or to be fixed to each other. As a result, the first electromagnetic valve and the second electromagnetic valve have the functions of fixing the first housing to the second housing and closing the first housing and the second housing. Compared with the prior art, the user can change the angle between the first housing and the second housing without overcoming the torque generated by the torsional force of the torque generating assembly, and also can prevent the electronic device from tilting and thus being damaged. In addition, the first electromagnetic valve and the second electromagnetic valve can replace the torque generating assembly and the locking assembly in the prior art structure so as to simplify the procedures of assembling the electronic device. Thus, the advantages of decreased working time, manufacturing cost, and enhanced manufacturing quality may be obtained.

### BRIEF DESCRIPTION OF THE DRAWINGS

The invention will become more fully understood from the detailed description given herein below illustration only, and thus is not limitative of the present invention, and wherein:

FIG. 1 is a schematic illustration showing a conventional electronic device;

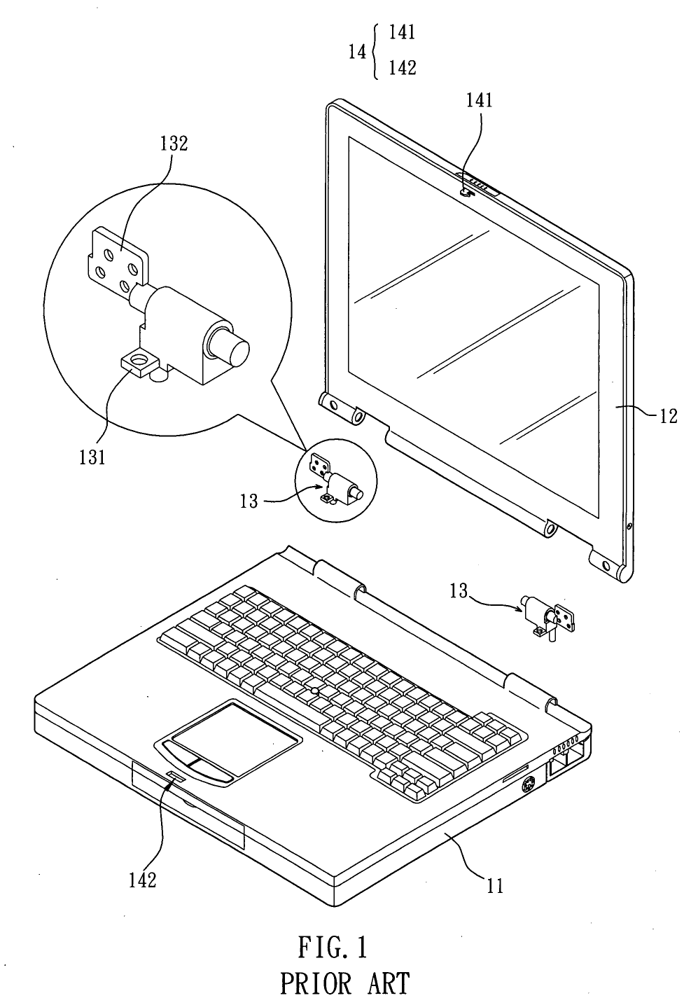

FIG. 2 is a schematic illustration showing an electronic device according to a preferred embodiment of the invention;

FIG. 3 is a schematic illustration showing the electronic device according to the preferred embodiment of the invention, wherein the first electromagnetic valve unlocks the axle; and

FIG. 4 is a schematic illustration showing the electronic device according to the preferred embodiment of the invention, wherein the first electromagnetic valve locks the axle.

### DETAILED DESCRIPTION OF THE INVENTION

The present invention will be apparent from the following detailed description, which proceeds with reference to the accompanying drawings, wherein the same references relate to the same elements.

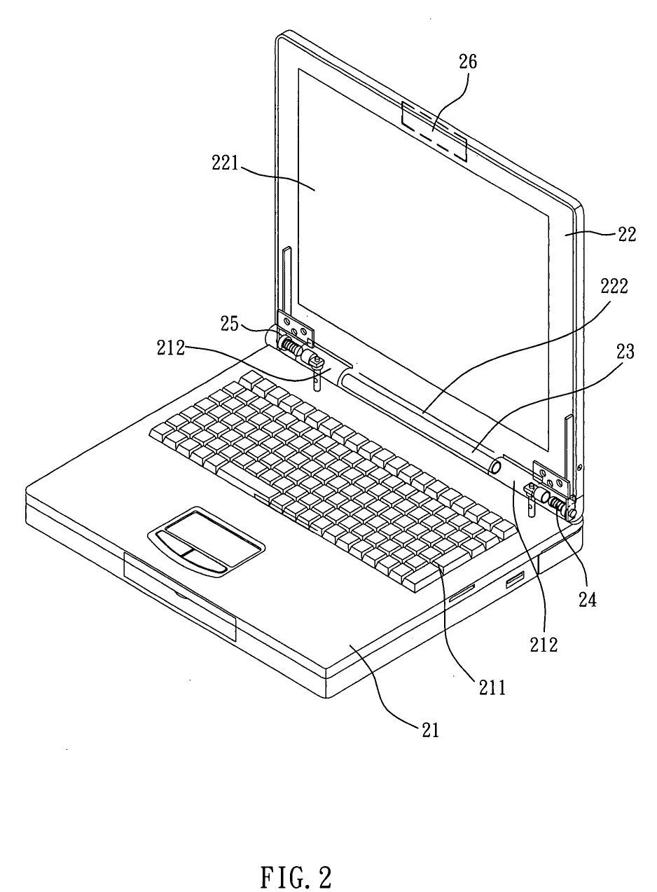

Referring to FIG. 2, an electronic device 2, such as a notebook computer, according to the preferred embodiment of the invention includes a first housing 21, a second housing 22, an axle 23 and a first electromagnetic valve 24.

As shown in FIG. 2, the first housing 21 is a host, and a central processing unit (not shown) and an input unit 211 are accommodated in the first housing 21. The input unit 211 is partially exposed out of the first housing 21. Thus, the user can input a data message to the central processing unit using the input unit 211. In addition, the first housing 21 has two first pivoting portions 212.

As shown in FIG. 2, the second housing 22 is disposed adjacent to one side of the first housing 21. In this embodiment, a display unit 221 is accommodated in the second housing 22 and the display unit 221 is electrically connected to the central processing unit. Consequently, the display unit 221 may display the data message processed by the central processing unit. In addition, the second housing 22 has a second pivoting portion 222, and the position of the second pivoting portion 222 corresponds to the position of the first pivoting portion 212 of the first housing 21.

As shown in FIG. 2, the first housing 21 and the second housing 22 are pivoted on the axle 23, and the first housing 21 and the second housing 22 may be rotated relative to each other through the axle 23. In this embodiment, the axle 23 is pivoted on the two first pivoting portions 212 of the first housing 21 and the second pivoting portion 222 of the second housing 22. Thus, the first housing 21 and the second housing 22 may be rotated relative to each other through the axle 23.

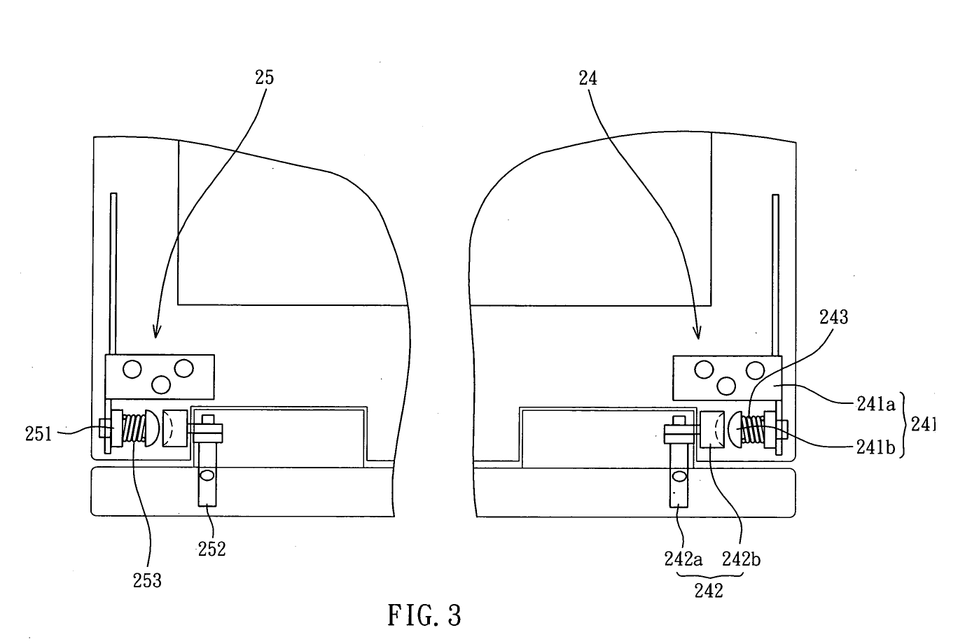

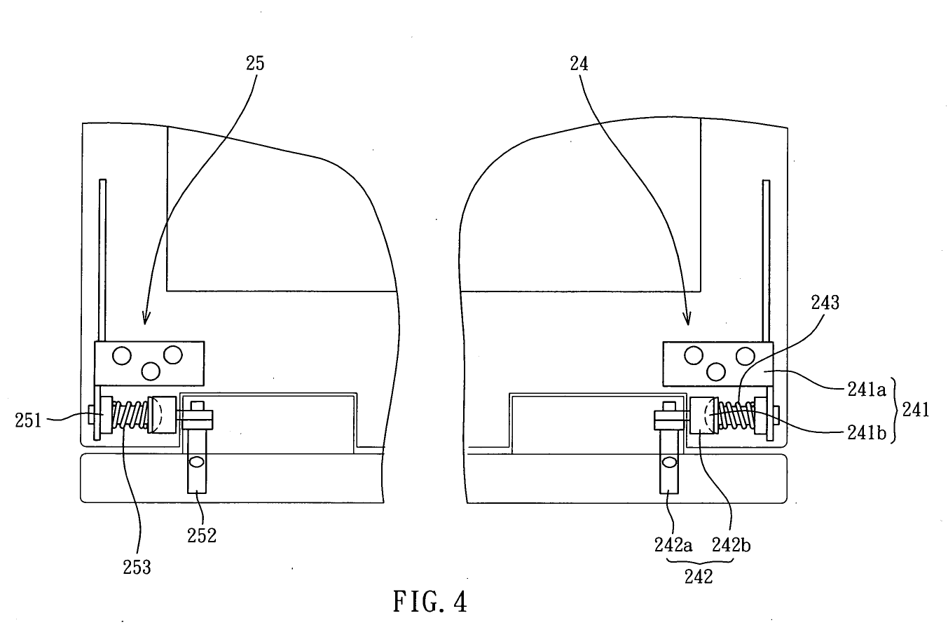

As shown in FIG. 2, the first electromagnetic valve 24 is disposed adjacent to the axle 23 to lock/unlock the axle 23. When the first electromagnetic valve 24 unlocks the axle 23, as shown in FIG. 3, the first housing 21 and the second housing 22 may be rotated relative to each other. When the first electromagnetic valve 24 locks the axle 23, as shown in FIG. 4, the first housing 21 and the second housing 22 are fixed to each other and cannot be rotated relative to each other.

In this embodiment, the first electromagnetic valve 24 is disposed adjacent to one end of the axle 23, as shown in FIG. 3. The first electromagnetic valve 24 has a first position limiting member 241 and a second position limiting member 242. The first position limiting member 241 has a first connection portion 241a and a first pressing portion 241b. The first connection portion 241a of the first position limiting member 241 is connected to the second housing 22, and the first pressing portion 241b of this embodiment is a roughly cylindrical rod, for example.

In addition, the second position limiting member 242 has a second connection portion 242a and a second pressing portion 242b. The second connection portion 242a of the second position limiting member 242 is connected to the first housing 21, and the second pressing portion 242b of this embodiment is a recess, for example. The second pressing portion 242b of the second position limiting member 242 is disposed corresponding to the first pressing portion 241b of the first position limiting member 241.

In this embodiment, when the first electromagnetic valve 24 unlocks the axle 23, the first electromagnetic valve 24 generates an electromagnetic force. At this time, the first pressing portion 241b of the first position limiting member 241 is attracted by the electromagnetic force and thus moved away from the second pressing portion 242b of the second position limiting member 242. Thus, the first housing 21 may be rotated relative to the second housing 22.

Next, as shown in FIG. 4, the first electromagnetic valve 24 of this embodiment further has a first elastic member 243. This first elastic member 243 is connected to the first position limiting member 241. When the first electromagnetic valve 24 locks the axle 23, the electromagnetic force disappears, and the first elastic member 243 pushes the first pressing portion 241b of the first position limiting member 241 against the second pressing portion 242b of the second position limiting member 242. Thus, the first housing 21 and the second housing 22 are fixed to each other and cannot be rotated relative to each other.

In addition, as shown in FIG. 2, the electronic device 2 of this embodiment further includes a second electromagnetic valve 25. The second electromagnetic valve 25 and the first electromagnetic valve 24 are respectively disposed adjacent to two ends of the axle 23. When the first electromagnetic valve 24 and the second electromagnetic valve 25 unlock the axle 23, the first housing 21 and the second housing 22 may be rotated relative to each other. When the first electromagnetic valve 24 and the second electromagnetic valve 25 lock the axle 23, the first housing 21 and the second housing 22 are fixed to each other and cannot be rotated relative to each other.

As shown in FIGS. 3 and 4, the second electromagnetic valve 25 of this embodiment has a third position limiting member 251, a fourth position limiting member 252 and a second elastic member 253. However, the positions of and the operating relationships between the third position limiting member 251, the fourth position limiting member 252 and the second elastic member 253 of the second electromagnetic valve 25 are the same as those of the first position limiting member 241, the second position limiting member 242 and the first elastic member 243 of the first electromagnetic valve 24, and detailed descriptions thereof will be omitted.

Referring again to FIG. 2, the electronic device 2 according to the preferred embodiment of the invention further includes an electromagnetic valve switch 26, which is electrically connected to the first electromagnetic valve 24 and the second electromagnetic valve 25 to control the first electromagnetic valve 24 and the second electromagnetic valve 25 to lock or unlock the axle 23. In this embodiment, the electromagnetic valve switch 26 is disposed at the second housing 22, the electromagnetic valve switch 26 is a touch switch, and the user can touch the electromagnetic valve switch 26 to control the locking/unlocking state of the first electromagnetic valve 24 and the second electromagnetic valve 25.

In addition, in order to make the invention clearer, the actual use of the electronic device 2 according to the preferred embodiment of the invention will be described with reference to the following example.

First, as shown in FIG. 2, the first housing 21 and the second housing 22 are in opened states. At this time, the first electromagnetic valve 24 and the second electromagnetic valve 25 lock the axle 23. Thus, the first position limiting member 241 presses against the second position limiting member 242, and the third position limiting member 251 presses against the fourth position limiting member 252, as shown in FIG. 4. In this locked state, the first housing 21 and the second housing 22 are fixed to each other and cannot be rotated relative to each other.

If the user wants to change the position of the first housing 21 relative to that of the second housing 22, he or she has to touch the electromagnetic valve switch 26 first. Consequently, the electromagnetic valve switch 26 controls the first electromagnetic valve 24 and the second electromagnetic valve 25 to unlock the axle 23. At this time, the first electromagnetic valve 24 and the second electromagnetic valve 25 respectively generate the electromagnetic forces, and the first position limiting member 241 and the third position limiting member 251 are respectively attracted by the electromagnetic forces and moved away from the second position limiting member 242 and the fourth position limiting member 252, as shown in FIG. 3. In this unlocked state, the first housing 21 and the second housing 22 can be rotated relative to each other.

To be more specific, the user may change the angle between the first housing 21 and the second housing 22 according to his/her requirement, or rotate the second housing 22 to a position, at which the second housing 22 and the first housing 21 are closed. Next, when the user again touches the electromagnetic valve switch 26, the first electromagnetic valve 24 and the second electromagnetic valve 25 lock the axle 23, as shown in FIG. 4. At this time, the electromagnetic forces of the first electromagnetic valve 24 and the second electromagnetic valve 25 disappear so that the first elastic member 243 can push the first position limiting member 241 against the second position limiting member 242, and the second elastic member 253 can push the third position limiting member 251 against the fourth position limiting member 252. Thus, the first housing 21 and the second housing 22 cannot be rotated relative to each other so that the first housing 21 and the second housing 22 are positioned at the angle adjusted by the user.

In addition, when the user touches the electromagnetic valve switch 26, the switch 26 can control the first electromagnetic valve 24 and the second electromagnetic valve 25 to unlock the axle 23; and when the user stops touching the electromagnetic valve switch 26, the switch 26 controls the first electromagnetic valve 24 and the second electromagnetic valve 25 to lock the axle 23. Thus, the user can use his/her hand to adjust the angle between the first housing 21 and the second housing 22.

In summary, the electronic device of the invention includes the first electromagnetic valve or may further include the second electromagnetic valve and the electromagnetic valve switch. Thus, the user can control the first electromagnetic valve and the second electromagnetic valve to unlock or lock the axle through the electromagnetic valve switch so as to control the first housing and the second housing to be rotated relative to each other or to be fixed to each other. As a result, the first electromagnetic valve and the second electromagnetic valve have the functions of fixing the first housing to the second housing and closing the first housing and the second housing. Compared with the prior art, the user can change the angle between the first housing and the second housing without overcoming the torque generated by the torsional force of the torque generating assembly, and also can prevent the electronic device from tilting and thus being damaged. In addition, the first electromagnetic valve and the second electromagnetic valve can replace the torque generating assembly and the locking assembly in the prior art structure so as to simplify the procedures of assembling the electronic device. Thus, the advantages of decreased working time, manufacturing cost, and enhanced manufacturing quality may be obtained.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. An electronic device, comprising:
a first housing;
a second housing disposed adjacent to one side of the first housing;
an axle pivoted on the first housing and the second housing, wherein the first housing and the second housing can be rotated relative to each other via the axle; and
a first electromagnetic valve disposed adjacent to the axle to lock/unlock the axle, wherein the first housing and the second housing can be rotated relative to each other when the first electromagnetic valve unlocks the axle, and the first housing and the second housing are fixed to each other and cannot be rotated relative to each other when the first electromagnetic valve locks the axle.

2. The device according to claim 1, wherein the first electromagnetic valve has a first position limiting member disposed in the second housing, and a second position limiting member disposed in the first housing, the first electromagnetic valve produces an electromagnetic force when the first electromagnetic valve unlocks the axle, and the first position limiting member is attracted by the electromagnetic force and is moved away from the second position limiting member.

3. The device according to claim 2, wherein the first electromagnetic valve further has a first elastic member connected to the first position limiting member, the electromagnetic force disappears when the first electromagnetic valve locks the axle, and the first elastic member pushes the first position limiting member against the second position limiting member.

4. The device according to claim 1, further comprising:
an electromagnetic valve switch, which is electrically connected to the first electromagnetic valve to control the first electromagnetic valve to lock or unlock the axle.

5. The device according to claim 4, wherein the electromagnetic valve switch is a touch switch.

6. The device according to claim 4, wherein the electromagnetic valve switch is disposed in the second housing.

7. The device according to claim 1, further comprising a second electromagnetic valve, wherein:
the first electromagnetic valve and the second electromagnetic valve are respectively disposed adjacent to two ends of the axle to lock/unlock the axle;
the first housing and the second housing can be rotated relative to each other when the first electromagnetic valve and the second electromagnetic valve unlock the axle; and
the first housing and the second housing are fixed to each other and cannot be rotated relative to each other when the first electromagnetic valve and the second electromagnetic valve lock the axle.

8. The device according to claim 7, wherein the second electromagnetic valve has a third position limiting member disposed in the second housing, and a fourth position limiting member disposed in the first housing, the second electromagnetic valve produces an electromagnetic force when the second electromagnetic valve unlocks the axle, and the third position limiting member is attracted by the electromagnetic force and is moved away from the fourth position limiting member.

9. The device according to claim 8, wherein the second electromagnetic valve further has a second elastic member connected to the third position limiting member, the electromagnetic force disappears when the second electromagnetic valve locks the axle, and the second elastic member pushes the third position limiting member against the fourth position limiting member.

10. The device according to claim 7, further comprising:
an electromagnetic valve switch, which is electrically connected to the first electromagnetic valve and the second electromagnetic valve to control the first electromagnetic valve and the second electromagnetic valve to lock or unlock the axle.

11. The device according to claim 10, wherein the electromagnetic valve switch is a touch switch.

12. The device according to claim 10, wherein the electromagnetic valve switch is disposed in the second housing.

13. The device according to claim 1, wherein the device is a notebook computer.
